(19) United States
(12) Patent Application Publication
(10) Pub. No.: US 2005/0229734 A1
(43) Pub. Date: Oct. 20, 2005

(54) Motor pinion and electric motor having motor pinion

(76) Inventors: Manfred Vogt, Braunlingen (DE); Heinz Gert Hagedorn, Rottweil (DE)

Correspondence Address: O'Shea, Getz & Kosakowski, P.C.;Suite 912, 1500 Main Street, Springfield, MA, 01115, US

(21) Appl. No.: 11/108,606

(22) Filed: Apr. 18, 2005

(30) Foreign Application Priority Data
Apr. 16, 2004 (DE) 10 2004 019 235.9

(51) Int. Cl. F02N 1/00

(52) U.S. Cl. 74/457

(57) ABSTRACT

The invention relates to an electric motor having a motor shaft on which motor pinion is or can be placed, to such a motor pinion, and to a method for fastening the motor pinion to the motor shaft. The starting point is a motor pinion having a shaft accommodating section for placement on and fastening to a motor shaft in rotationally rigid fashion, the shaft accommodating section having a wall for encompassing the motor shaft. The advantageous fastening comes about in that at least a part of the wall is fashioned so as to be constrictable for restraining the motor shaft. In mounting, the wall is compressed against the motor shaft by a nut, the wall advantageously having an increasing external circumference.

### PRIORITY INFORMATION

This application claims priority from German application 10 2004 019 235.9 filed Apr. 16, 2005, which is hereby incorporated by reference.

### BACKGROUND OF THE INVENTION

The present invention relates to the field of motor pinions, and in particular to the field of motor pinions for electric motors.

Electric motors that are employed, for example, as a vehicle seat drive for adjusting a vehicle seat commonly have a housing from which a motor shaft protrudes. The motor shaft can be rotated by an electric motor. A motor pinion is commonly placed on the motor shaft for transferring the rotational motion or the rotational force, and the motor pinion has a shaft accommodating section for accommodating the motor shaft. The motor shaft is fastened in rotationally rigid fashion to the shaft accommodating section.

In a known arrangement for fastening the motor shaft to the motor pinion or to its shaft accommodating section, a threaded hole leads laterally through a lateral wall of the motor pinion to the inserted motor shaft. The motor shaft can be clamped fast in the shaft accommodating section by screwing in a set screw or headless screw through the lateral threaded hole. However, such an arrangement has the disadvantage that it produces an imbalance upon a rotation because, as a result of the threaded hole, material or mass is missing in comparison with the remaining circumference and, additionally, a mass differing in action therefrom has an influence because of the laterally inserted set screw.

According to another known arrangement, a motor pinion having a shaft accommodating section is pressed onto the distal end of a motor shaft and fastened with a pin. The motor shaft and the motor pinion have a hole passing laterally all the way through them, by which hole the pin is guided. While such an arrangement offers radial securing against rotation, it also leads to an imbalance. Furthermore, the holes in the shaft and in the pinion must be properly aligned with each other in mounting, which entails some effort.

Therefore, there is a need for an improved motor pinion that facilitates mounting a shaft of an electric motor.

### SUMMARY OF THE INVENTION

A motor pinion includes a shaft accommodating section that is fastened to a motor shaft in rotationally rigid fashion via the shaft accommodating section, where at least a part or section of the shaft accommodating section includes a wall fashioned so as to be constrictable and being compressed by a compression element against the motor shaft. The motor shaft may be driven by an electric motor.

At least one slot or recess may lead through the wall, and the slot or recess facilitates narrowing the cross section of the shaft accommodating section. Similarly, the slot or recess may lead into the wall from the rear end section of the shaft accommodating section, from where the motor shaft can be inserted.

The wall of the shaft accommodating section may include an external thread, so that a nut can be screwed on to compress the wall against inserted motor shaft. The external thread may include an outside diameter narrowing toward the rear or open outer end of the shaft accommodating section. The nut may include an internal thread that narrows oppositely to a direction of screwing onto the external thread. The nut may include a concentric external circumference.

The wall of the shaft accommodating section may include an outside diameter narrowing toward the rear end, into which end the motor shaft can be inserted. The wall may be made of an unhardened or only partly hardened material and a pinion proper of the motor pinion is hardened.

The shaft accommodating section may be fashioned as a collar on the rear side of a pinion proper of the motor pinion. The shaft accommodating section is compressed by screwing a nut onto a narrowingly fashioned section of the shaft accommodating section.

The electric motor may be fabricated and delivered with a motor shaft as a standardized component. Advantageously, the number of usual variants with respect to the diameter of the shaft, with respect to shafts with or without hole, or shafts with or without thread may be reduced to one or a small number of standard motor shafts. The motor pinion may be placed on such a standardized motor shaft in a relatively simple manner.

The rotationally symmetric structure of the components as a whole facilitates mounting the motor pinion on the motor shaft to reduce the likelihood of an imbalance. In addition, mounting or dismantling of the motor pinion on the motor shaft can be performed with conventional tools. The motor pinion can nevertheless be fastened to the motor shaft in a permanently rigid fashion with security against twisting.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 depicts, in disassembled arrangement and in a partial cutaway view, the distal end of a motor shaft, a motor pinion to be placed thereon, and a nut for compressing the motor pinion on the motor shaft; and

FIG. 2 depicts this arrangement in the assembled condition.

### DETAILED DESCRIPTION OF THE INVENTION

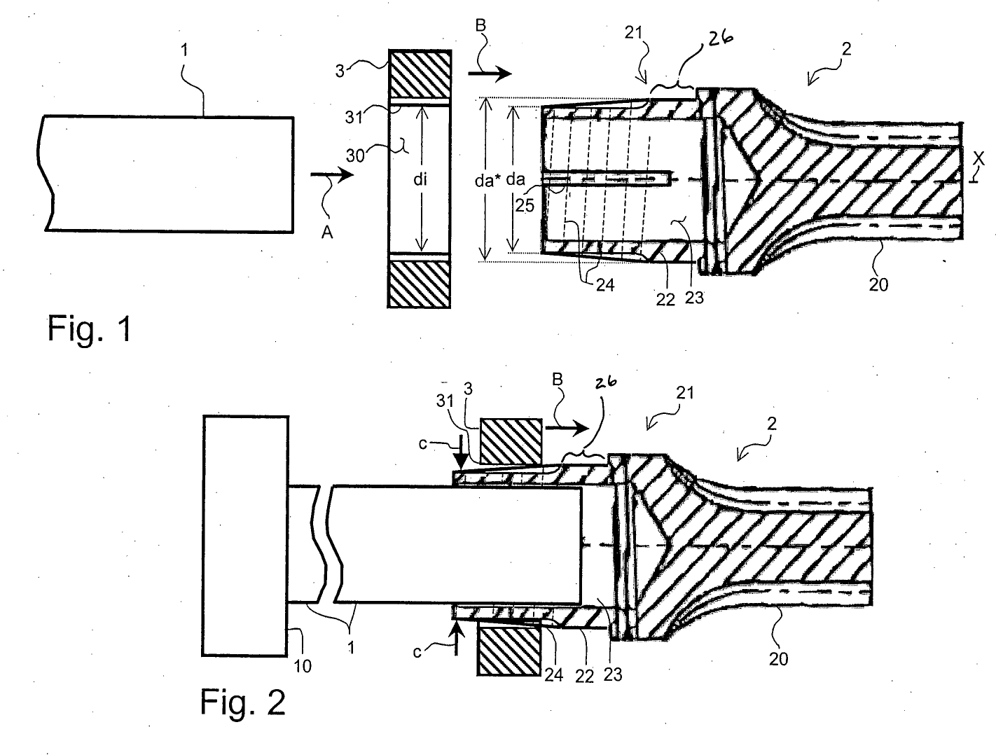

FIG. 1 depicts, in disassembled arrangement and in a partial cutaway view, the distal end of a motor shaft, a motor pinion to be placed thereon, and a nut for compressing the motor pinion on the motor shaft. FIG. 2 depicts this arrangement in the assembled condition. Referring to FIGS. 1 and 2, the motor shaft 1 protrudes from the housing of a motor 10 (e.g., an electric motor) that may serve primarily as an assistive mechanism in vehicle components. For example, the motor 10 may be employed for adjusting a vehicle seat or a vehicle window. However, use in other application areas is possible as well.

The motor pinion 2 comprises a front section, which forms pinion proper 20, and a rear shaft accommodating section 21. The shaft accommodating section 21 fastens the motor pinion 2 to the motor shaft 1 in the direction of a common longitudinal axis X, which corresponds to the axis of rotation of the motor shaft 1.

The shaft accommodating section 21 comprises a wall 22 in the form of a collar fashioned on or fastened to the rear of the pinion 20. The wall 22 encloses a space open to the rear, to form a shaft accommodating hole 23. The inside diameter of the shaft accommodating hole 23 is preferably not much larger than the outside diameter of the motor shaft 1, so that the motor shaft 1 can be inserted into the shaft accommodating hole 23 with, preferably, only slight play.

To fasten the motor shaft 1 in the shaft accommodating hole 23 or to the wall 22 of the shaft accommodating section 21 in rotationally rigid fashion, the wall 22 is elastically and/or plastically deformable in order to diminish the inside diameter of the shaft accommodating hole 23 after the insertion of the motor shaft 1. The motor shaft 1 is rigidly restrained in the shaft accommodating section 21 by the diminution.

Externally, the wall 22 of the shaft accommodating section 21 has an external thread 24 onto which a nut 3 can be screwed for compression. The nut 3 includes a threaded hole 30 having an internal thread 31. The nut 3 is chosen of such size that the internal thread 31 can be screwed onto the rear end of the shaft accommodating section 21 or onto its external thread 24.

The external circumference of the external thread 24 of the shaft accommodating section 21 narrows from the front to the rear end of the shaft accommodating section 21. The outside diameter da* of the external thread 24 at its front end is thus greater than the inside diameter di of internal thread 31. The rear end of the external thread 24 has an outside diameter da that is smaller than or equal to the inside diameter di of the internal thread 31. When the nut 3 is screwed onto the shaft accommodating section 21, a radially inwardly directed compression force is exerted on the wall 22 of the shaft accommodating section 21.

In order that the wall 22 of the shaft accommodating section 21 can be compressed against the external circumference of the motor shaft 1 when the nut 3 is screwed on, the wall 22 has at least one slot 25. The at least one slot 25 extends from the rear end of the shaft accommodating section 21 in the direction toward the front.

The motor pinion 2 may be mounted on the motor shaft 1 by fastening the shaft accommodating section 21 on the motor shaft 1 in a rotationally rigid manner. Before insertion into the shaft accommodating section 21, the motor shaft 1 is guided through the threaded hole 30 of the nut 3. It is also possible to screw the nut 3 partway onto the rear end section of the external thread 24 of the shaft accommodating section 21 in advance. After the motor shaft 1 has been inserted into the shaft accommodating hole 23 of the shaft accommodating section 21, the nut 3 is screwed (B) onto the rearwardly narrowing fashioned section of the shaft accommodating section. As soon as the inside diameter di of the internal thread 31 of the nut 3 becomes smaller than the outside diameter da of the external thread 24 of the shaft accommodating section 21, screwing the nut 3 further onto the shaft accommodating section 21 squeezes the wall 22 together in the inward radial direction. As a result, the wall 22 is compressed (C) against the motor shaft 1.

When the wall 22 is made of an elastic material, loosening the nut 3 also loosens the motor shaft 1 from the shaft accommodating section 21, so that replacement of the motor pinion 2 or of the motor with the motor shaft 1 is possible.

Fastening of the motor pinion 2 to the motor shaft 1 is effected by sliding the motor pinion 2, with the slotted collar formed by the shaft accommodating section 21, over the distal shaft end of the motor shaft 1 and clamping it thereon. The inside diameter of the shaft accommodating hole 23 may be equal to the outside diameter of the motor shaft 1, or even smaller as appropriate, so that the motor shaft 1 is prefastened in the shaft accommodating section 21 even without the use of the nut 3. The nut 3, serving as a compression nut, is subsequently screwed onto the external thread 24 of the shaft accommodating section 21, which is attached in the manner of a flange, and in this way the motor pinion 2 is rigidly fixed to the motor shaft 1.

The external thread 24 may be conoidal or conical in shape. In addition, the external thread 24 and the internal thread 31 may be matched to each other in such fashion that they interlock with each other.

Besides the external thread 24 narrowing in the rearward direction, the internal thread 31 of the nut 3 may vary with respect to the inside diameter di, and in particular may narrow toward the rear end. As a further exemplary alternative, if the external thread 24 does not narrow, a narrowing can be fashioned with a land on the wall 22 running in ramp fashion from the rear end to the front end of the external thread 24.

In the manufacture of the motor pinion 2, it is preferably hardened, in particular induction-hardened, in the region of the pinion proper 20 or in the region of its gear teeth, while the shaft accommodating section 21 is preferably not hardened or only partly hardened in order to preserve some elasticity there.

With respect to the sizing of the motor pinion 2, a multiplicity of variants is possible with regard to its individual components. For example, the motor pinion 2 can have a diameter in the region of the gear teeth or of the pinion proper 20 that is larger or smaller than in the region of the shaft accommodating section 21. If the external circumference of the gear teeth or of the pinion 20 is larger than the external circumference of the motor shaft 1, the motor pinion 2 can also have a shaft accommodating hole 23 passing through the motor pinion 2 in axial direction X. In this way the motor pinion 2 can be placed on the motor shaft 1 and arbitrarily slid and positioned along the motor shaft before the shaft accommodating section 21 is fixed on the motor shaft 1 with the nut 3.

The position and shape of the slot 25 can be varied. Rather than a slot leading from the outside to the inside of the wall 22, for example, a notch leading from outside inwardly can also be fashioned in the wall 22. The slot 25 or such a notch also need not necessarily begin at the rear end of the shaft accommodating section 21, for example not when a section of the shaft accommodating section 21 farther away from the rear end is to be clamped.

Instead of a narrowing of the external circumference of the external thread 24 by a variation in tooth height along the external thread 24, the compressing action can also be achieved by varying the external circumference of the wall 22 in the region of the external thread 24 even if the tooth height is continuous over the external thread 24. Thus an outside diameter da narrowing toward, in particular, the rear end can be achieved by narrowing the external circumference of the wall 22 and/or by varying the tooth height in this region.

Besides the possibility of screwing on a standard nut, a nut with a concentric external circumference may be used, so that an imbalance upon rotation is avoided.

For screwing the nut 3 onto the rearward motor pinion 2, the nut must be gripped appropriately. This is commonly effected with tools, for example pliers, in particular for example a dihedron. In order to set the pliers 26 on the external circumference of the motor pinion 2, a portion 26 of the circumference can be fashioned as a purchase section. To this end, a portion of the shaft accommodating section 21 rearward of the external thread 24, that is, between the external thread 24 and the pinion proper 20, can preferably be fashioned appropriately. In particular, a portion of grip section 26 can be flattened on two opposite sides in order to offer a purchase to pliers or a wrench in appropriate fashion. Another possibility is to roughen or flute the circumferential surface in order, on the one hand, to offer a purchase to pliers and, on the other, to reduce the imbalance upon rotation of the motor pinion 2 due to flattening. Alternatively, a rearward portion of the pinion proper 20, that is, a transitional portion to the shaft accommodating section 21, may be fashioned as a purchase section.

In one embodiment for holding the motor pinion 2 in rotationally rigid fashion is placement of a mating gear on the teeth of the pinion proper 20 from the front, such a mating gear having appropriate holding or fastening sections for gripping or fixation against rotation.

Preferred as a further development for the temporary fixation of the motor pinion 2 while the nut 3 is being screwed on is a frontal recess of the nature of a hexagonal socket, into which a corresponding hexagonal-socket wrench is inserted for fixation. Such procedures and developments for the temporary fixation of the motor pinion 2 are significant on their own and offer special advantages in the case of the corresponding embodiments.

If the nut 3 to be screwed on is a typical hexagonal nut, it can be encompassed with a corresponding wrench and screwed onto the external thread 24 of the motor pinion 2. If the nut 3 is fashioned with a concentric external circumference, it is gripped for example with pliers. In this case, the external circumference of the nut 3 is preferably roughened or provided with flutes parallel to longitudinal axis X in order to offer a purchase to pliers.

Although the present invention has been shown and described with respect to several preferred embodiments thereof, various changes, omissions and additions to the form and detail thereof, may be made therein, without departing from the spirit and scope of the invention.

1. An electric motor having a motor shaft, comprising:
a motor pinion that includes a shaft accommodating section that secures the motor shaft to the motor pinion in rotationally rigid fashion; and
wherein the shaft accommodating section includes a wall that forms a recess and is configured and arranged to be constrictable and compressed against the motor shaft.

2. A motor pinion comprising a shaft accommodating section for placement and fastening in rotationally rigid fashion on a motor shaft, the shaft accommodating section having a wall for at least partially encompassing the motor shaft, wherein at least a part of the wall is fashioned so as to be constrictable for restraining the motor shaft.

3. The motor pinion of claim 2, wherein the motor pinion is configured and arranged as an electric motor pinion.

4. The electric motor of claim 1, wherein at least one slot or recess leads through the wall, the slot or recess making it possible to narrow the cross section of the shaft accommodating section.

5. The electric motor of claim 4 wherein the slot or recess leads into the wall from the rear end section of the shaft accommodating section, from where the motor shaft can be inserted.

6. The electric motor of claim 1, wherein the wall comprises an external thread onto which a nut can be screwed in order to compress the wall against the inserted motor shaft.

7. The electric motor of claim 6, wherein the external thread has an outside diameter (da) narrowing toward the rear end of the shaft accommodating section, into which end such a motor shaft can be inserted.

8. The electric motor of claim 6, wherein the nut comprises an internal thread, the internal thread narrowing in the direction opposite to the direction of screwing onto (B) the external thread.

9. The electric motor of claim 6, wherein the nut comprises a concentric external circumference.

10. The electric motor of claim 1, wherein the wall of the shaft accommodating section comprises an outside diameter (da) narrowing toward the rear end, into which end such a motor shaft can be inserted.

11. The electric motor of claim 10, wherein the wall is made of an unhardened or only partly hardened material and a pinion proper of the motor pinion is hardened.

12. The electric motor of claim 1, wherein the shaft accommodating section is configured as a collar on the rear side of a pinion proper of the motor pinion.

13. A method for fastening a motor pinion on a motor shaft of an electric motor, comprising the steps of:
placing the motor pinion, with a shaft accommodating section fashioned thereon, on the motor shaft; and
fastening the shaft accommodating section to the motor shaft in rotationally rigid fashion,
wherein
the compression of the shaft accommodating section against the motor shaft after placement (A) in order to fasten (C) these to each other (B, C).

14. The method of claim 13, wherein the shaft accommodating section is compressed by screwing a nut onto a narrowingly fashioned section of the shaft accommodating section (B).
